(19) United States
(12) Patent Application Publication
(10) Pub. No.: US 2004/0128147 A1
(43) Pub. Date: Jul. 1, 2004

(54) Method and system to implement complex pricing rules

(76) Inventors: Sundar Vallinayagam, Pittsburgh, PA (US); Shankar Krishnamurthy, Pittsburgh, PA (US); Ravi Koka, Pittsburgh, PA (US)

Correspondence Address: Cohen & Grigsby, P.C., 15th Floor, 11 Stanwix Street, Pittsburgh, PA, 15222, US

(21) Appl. No.: 10/329,627

(22) Filed: Dec. 26, 2002

(51) Int. Cl. G06F 17/60; G06G 7/00; G06F 17/00

(52) U.S. Cl. 705/1; 705/4; 705/400

(57) ABSTRACT

A method and system for specification and execution of complex pricing calculations for the insurance industry using a declarative approach to specify and execute the rules. Pricing Illustrator/Configuration is a unique combination of a process and system that defines, tests and implements complex business computations such as premium computations for the insurance sector. The invention provides a repeatable and well-defined process for specification, design and implementation of the rules and a flexible, rule based calculation/pricing engine that implements the rules defined without any programming. Using the concept of declarative rules, Microsoft Excel as the design time tool to specify the rules and execute the spreadsheet at runtime to compute the premium, the invention defines, tests and refines the rules in relation to a business need.

### BACKGROUND OF THE INVENTION

Insurance companies rely on complex rules and computations to determine the price, or premium, that they charge for their products. The rules governing the calculation of insurance premiums are defined by organizations such as ISO and NCCI, and by custom rules defined by the insurance company.

The current process for interpreting the standard rules, combining them with the company specific rules, translating these declarative rules into technical specifications and implementing them in software programs on a computer system is complex and time-consuming. The process involves numerous manual steps and many persons with different areas of expertise (actuaries, business analysts, technical analysts and IT staff). Because of the complexity of the process, the absence of a well-defined methodology, and the number of steps involved, errors can be introduced in the process. Further, this is a time consuming process, where the complex business rules for calculating the premiums, typically declarative rules, are eventually implemented as a software program. The time, complexity and high error rate in translating the declarative rules into software code has been a persistent problem in the prior art.

Accordingly, there was a need in the prior art for a method and system to define, test and implement complex business computations, such as insurance premium computations. The invention allows a business user to easily and quickly define, test and refine the rules by adopting a repeatable and well-defined process for specification, design and implementation of the computations as declarative business rules. The invention uses software applications that business analysts currently use to define rules, and a flexible, rule based calculation/pricing engine that executes the rules without special programming. The invention applies the concept of declarative rules, uses Microsoft Excel as the design time tool for specification of the rules, and facilitates the execution of the spreadsheet at runtime for the computation of the premium.

In addition to insurance premium calculations, the invention can be used for other types of computations for other products and services that are based on complex business rules.

### SUMMARY OF THE INVENTION

In accordance with the subject invention, a process and software are combined to define, test and implement complex business computations such as insurance premium calculations. The invention provides a repeatable, defined process for the specification, design and implementation of the calculations as declarative business rules and a flexible, rule based calculation/pricing engine that implements the rules without programming. Using declarative rules that are defined in a spreadsheet, Microsoft Excel as the design time tool for specifications of the rules in the spreadsheet and execution of the spreadsheet at runtime for the computation of the premium, the invention empowers the business user to rapidly define, test and refine the rules as needed.

The benefits of the invention can be summarized as:

General:

Allows insurance carriers to introduce new products quickly

Minimizes or reduces the potential implementation defects

Enhances productivity of the business users in making business rule changes

Process and Software:

Separates the rules from the software systems, thus making the IT systems flexible and agile

Preserves business assets as high level rules instead of burying them in code

Executes directly the design time artifacts:

Eliminates the need for translating the rules into application code

Eliminates the time lag between the specification and execution of rules

Enables rapid review and refinement of the rules

Capability to deploy the software as a callable module, Web application or as a Web service

Open architecture provides flexibility for custom configurations and databases

Supports output in XML, HTML and native language formats

Other objects and advantages of the subject invention will become apparent to those skilled in the art as a description of a presently preferred embodiment thereof proceeds.

### BRIEF DESCRIPTION OF THE DRAWINGS

A presently preferred embodiment of the invention disclosed herein is shown and described in connection with the accompanying drawings wherein:

FIG. 1 shows a typical prior art method for making calculations.

FIG. 2 shows a logic diagram of a preferred embodiment of the presently disclosed invention.

FIG. 3 discloses technical architecture of the disclosed method and system to making calculations.

FIG. 4 shows a typical deployment configuration of the disclosed method and system.

### DESCRIPTION OF A PRESENTLY PREFERRED EMBODIMENT OF THE INVENTION

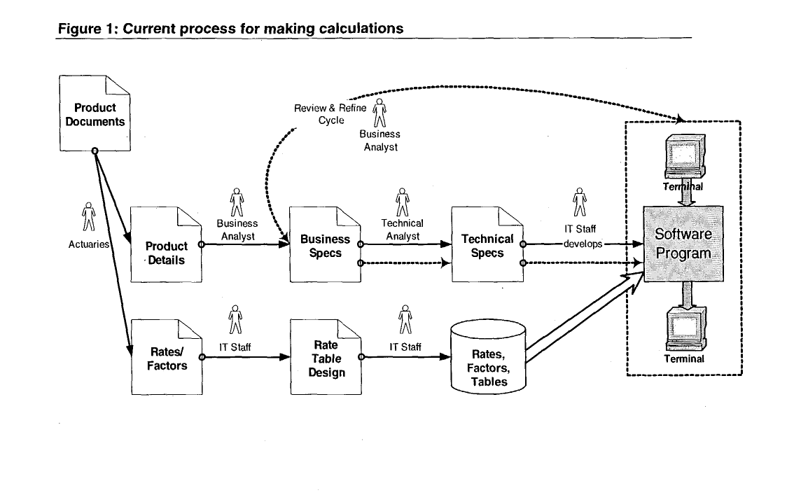

The prior art process of introducing a new insurance product or introducing new coverages or premium calculation changes involved numerous persons and was time consuming. As a specific example, FIG. 1 shows a schematic overview of a prior art process for implementing a new product or a rating change.

The prior art process involved numerous manual processes that included many persons with different areas of expertise (actuaries, business analysts, technical analysts and IT staff). Because of the complexity of the process, a lack of process definition, and a large number of process steps, the prior art process was subject to error. Further, this process was effort-intensive and required substantial time to complete. Typically, the complex business rules for calculating the premiums were declarative rules that were implemented through a software program.

The invention herein disclosed improves the prior art process. The method and system of the disclosed invention enables business analysts to document specifications and rules in a form with which they are familiar, specifically by using spreadsheet software such as Microsoft Excel. The rules are accessed and executed by a software program. This eliminates the need for programmers to translate the rules into software code.

The method and system herein disclosed combine a process and software to define, implement and test complex business computations such as premium computations for the insurance sector. The invention herein disclosed provides a method and system that is both repeatable and well defined. The invention provides for the specification, design and implementation of the rules and also provides for a flexible, rule based calculation/pricing engine that implements the rules defined without the necessity of writing or rewriting program code.

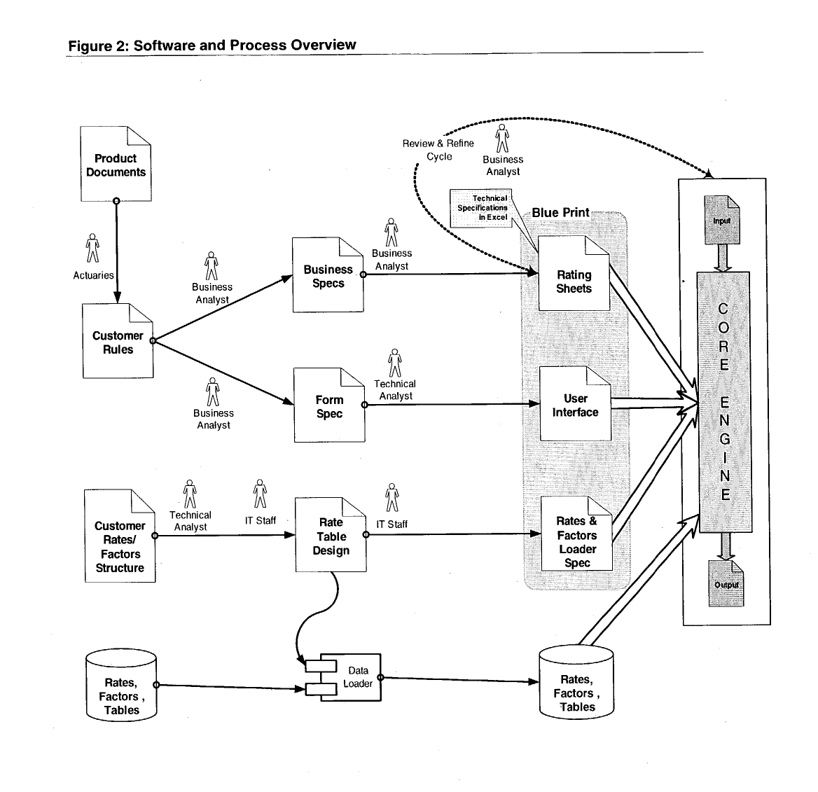

A presently preferred embodiment of the disclosed invention is shown in FIG. 2. FIG. 2 shows the use of declarative rules, a design time tool (such as Microsoft Excel) to specify the rules in spreadsheets, and the execution of those spreadsheets at runtime to compute a premium. The invention enables the user to define, test and refine the declarative rules in relation to a new product or a premium calculation change.

The invention also has many applications outside the field of insurance. It is applicable to any application wherein computations are based on complex business rules.

As used herein, the following terms are defined as follows:

Actuaries:

Actuaries are the individuals who define new products, define changes to the business rules for rating and define rates and factors for the new products and in the context of proposed changes.

Business Analysts:

Business Analysts understand the insurance domain; the intricacies of specific lines of business, the rules and regulations stipulated by the standards organizations and federal/state regulations. They translate the product definitions and changes proposed by the actuaries into structured business specifications.

Technical Analysts:

Technical Analysts translate the business specifications developed by business analysts into technical documents that the programming staff can use to implement the business rules in the software programs. This translation requires a good understanding of the insurance domain as well as the Information Technology (IT) side of the organization.

IT Staff:

The IT Staff is the programming staff responsible for implementing the technical specifications of new products and changes in the software/applications that perform the premium calculations. Typically, the programming staff has a cursory understanding of the insurance domain and are not considered experts of the domain.

Blueprint

Blueprint is a term used in this invention to refer to a set of documents that define, in a clear and concise way the business calculations that need to be performed to compute a set of results from a set of inputs, rates and factors.

Business Specifications:

These documents contain the definitions, assumptions and the business rules that describe the process of computing the premium for a specific line of business. Business Specifications are comprehensive documents that include descriptions of all possible scenarios, exceptions and variations of the rules (including state-specific variations).

Technical Specifications:

These documents describe the business rules in a manner that the programming staff can understand and use in developing software applications to perform the premium calculations.

Rates/Factors:

These are baseline rates, factors and decision tables that are used in the premium calculations.

The descriptions of the process steps and software components are described in later sections in the context of their use.

Business Rules:

Business rules define a particular aspect of a business operation. Depending on the particular application and use, business rules are classified as process rules, computation rules, inference rules or policies.

An example of a process rule is “Manager's authorization is required for credit card purchases exceeding $1000 in value”.

An example of a computation rule is “Assess a coal mine subsidence surcharge in territories that have been undermined”.

An example of an inference rule is “An unmarried youth residing in a campus 100 miles away from home can be considered ‘married’ for the purposes of insurance rating”.

In the context of the presently disclosed invention, business rules include computation rules and inference rules. Those two types of rules play a key role in complex business calculations such as insurance premium calculations.

Computation rules and inference rules are defined in accordance with an entity's business strategy and in accordance with applicable laws and guidelines issued by governments or standards organizations. Implementing many business rules has caused substantial difficulties because: the rules are sometimes vague or subject to interpretation; they are expressed in special terminology or industry terms (such as the insurance industry) that are known and understood or correctly interpreted by only a limited number of people; and that they are incomplete from an implementation standpoint or sequenced so as to make automation thereof difficult. Largely for those reasons, it has been difficult to translate business rules into technical specifications and to implement them in software programs.

The invention that is disclosed herein includes a method and system for translating business rules into a precise specification that is arranged for convenient implementation in a software program. In the preferred embodiment of the disclosed invention, the business rules (such as the rules that lead to the calculation of premium) are declarative rules. The business rules that define the calculation of the premium have the following characteristics:

Calculations are based on a set of input parameters. For example, the profile of the car, place of residence, profile of the drivers and coverages required are typical input parameters in the calculation of the premium for personal auto insurance.

A final premium and intermediate values are defined as the results of calculations or the output parameters. For example, a total premium for an insurance policy that covers multiple autos where the total premium is comprised of itemized premiums for each vehicle.

Rates, Factors, and other supporting data are dynamically loaded from databases as a function of the input parameters, derived parameters and a set of properties.

The calculation is based on a step by step process, where each step can be sub-divided into smaller steps that can be defined clearly and succinctly as an arithmetic expression with input parameters, derived values, and dynamically loaded values.

Since these characteristics are representative of the declarative process for defining the rules, the rules are referred to as “declarative” rules.

In addition, the disclosed process defines a way to specify inference rules as decision tables that are precise and that can be implemented automatically as, for example, in a software application.

The presently disclosed invention includes both a method and system.

The process is shown in FIG. 2. As illustrated in FIG. 2, the process defines a method and format to create a precise specification from the business rules. The result of the process is called the Blueprint. Analogous to the way in which an architect uses a blueprint to precisely specify details of a building, the Blueprint is used to implement business calculations. A specific Blueprint corresponds to each complex calculation that is to be performed.

For example, if an insurance company sells different insurance products such as personal automobile insurance and homeowner insurance, one Blueprint corresponds to the personal automobile insurance and another Blueprint corresponds to the homeowner insurance.

The Blueprint includes the following elements:

1. Technical Specification

2. Rating Sheets

3. Form Specification

4. Modifier Specification

5. Rate Loader Specification

6. XML Style Sheets for output presentation

The “Technical Specification” is a text document that describes the business rules that are applicable and necessary to perform the computation. The Technical Specification is not used directly in implementation of the Blueprint, but it serves as an intermediate document that is used in developing the rest of the Blueprint.

“Rating Sheets” are Microsoft Excel documents that precisely specify the intent of the calculations as formulas. The Rating Sheets are organized into four sections or worksheets:

1. An input worksheet defines all of the inputs that are needed to perform the calculation for all situations. A particular calculation may require only a subset of the total set of inputs.

2. A rates and factors worksheet defines all of the possible rates and factors that are needed to perform the computation. A particular calculation may require only a subset of the total set of rates and factors.

3. Calculation worksheets detail the steps, sub-steps and formula that are needed to complete the computation. Relatively long, complex calculations are divided into a number of worksheets each of which completes one logical part of the computation. For example, an insurance premium calculation for an automobile involves calculation of premiums for various coverages such as bodily injury liability, property damage, comprehensive, collision, and other coverages. The Blueprint in this case would separate the total premium computation into several calculation worksheets, one for each coverage.

4. An output worksheet defines all of the outputs applicable for a particular calculation and shows all of the intermediate values and the final results of the calculation. Only a subset of outputs may be applicable to a particular calculation.

The “Form Specification” is an optional spreadsheet document that defines the user interface for the calculation. The form specification is used to automatically create a Web-based user interface that will permit the users to specify the inputs for a calculation. The Form Specification is a table in which each row defines a field in the user interface. For each field, a number of other properties are defined such as the page names (forms are divided into several pages to accept only a reasonable amount of information from the user at one time), field prompt, field help, whether the field is a required field, field appearance, valid values and default values.

The “Modifier Specification” is an optional spreadsheet document that defines any dynamic behavior of fields defined in the Form Specification. The information in the Modifier Specification specifies the conditions under which a field in the Form Specification is to be shown or hidden and if shown, what appearance changes or other changes it might have to undergo for that situation. For example, a type of auto insurance coverage called Optional Basic Economy Loss coverage is available only in the state of New York. Accordingly, the Modifier Specification will document this and the user interface will hide fields for this coverage for all states except New York.

The “Rate Loader Specification” is a spreadsheet document that specifies how rates and factors are to be loaded during the calculation, and the source of the data.

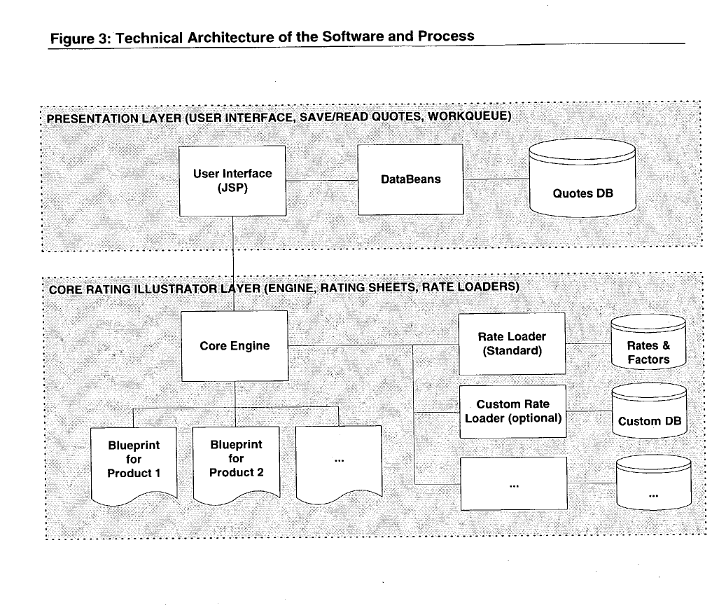

FIG. 3 is a diagram that shows the technical architecture of the system of the invention. The typical components of the software include:

1. A User Interface

The User interface is an optional component although most implementations use a user interface in one form or another. However, at a high level, the system is independent of the user interface and supports both interactive and non-interactive (also referred to as batch) applications equally well

2. Core Engine

This is the core component that automates the implementation of the calculations.

3. Rate Loader

This is the component that is responsible for obtaining the rates and factors that are needed to perform the calculation. This component uses the Rate Loader Specification of the Blueprint to determine what needs to be done.

The three components communicate using a well-defined interface that enables customizing one component independent of another.

The User Interface is responsible for the following:

1. Presenting the user interface forms to the user

2. Gathering input

3. Validating the inputs

4. Invoking the Core Engine and supplying the inputs

5. Processing the results and displaying these results to the user

DataBeans are optional components for data access. These components are used to store information collected from the input and the results of the computations in a database.

Quotes DB is the database where the information collected from the input and the results of the computations will reside. In the preferred embodiment this is a relational database.

The key component of the software is the Core Engine. The Core Engine operates as follows:

1. The Core Engine receives a set of inputs from a system (either interactive or non-interactive) that requires the system to perform a business calculation.

2. The Core Engine determines the appropriate Blueprint to load. Typically there is one Blueprint for each complex business calculation. There is an aspect in the Core Engine that determines which Blueprint is selected for use based on the set of inputs received.

3. The Core Engine reads the appropriate Blueprint. Based on the information in the Blueprint, the Core Engine determines the rates, factors and other data that is required to successfully perform the calculation.

4. The Core Engine loads the appropriate data using the Rate Loader Component

5. It then computes the results and prepares the output in a format recognizable by the system that provided the inputs

The Rate Loader component is responsible for the following:

1. Reading the Rate Loader specification for the specified Blueprint.

2. Using the inputs and intermediate results to fetch appropriate rates and factors and supply the data back to the Core Engine.

3. Repeating step 2 for each stage of the calculation because data must be loaded in stages rather than in a single step.

Essentially, the data is loaded dynamically and as required, since the data is required at different stages and can be dependent on intermediate values or results. For example, the discount percentage depends on intermediate results. Therefore, the discount percentage cannot be loaded until appropriate intermediate results are computed. Loading the discount percentage before the appropriate intermediate results are computed will lead to incorrect results.

Rate Loader specification clearly defines the stages, the values required to fetch data and the source of the data.

Custom Rate Loader is an optional component that enhances the functionality of Rate Loader. Custom Rate Loader is needed only when there is a need to access rates and factors from a database that is structurally different from the standard rates and factors database

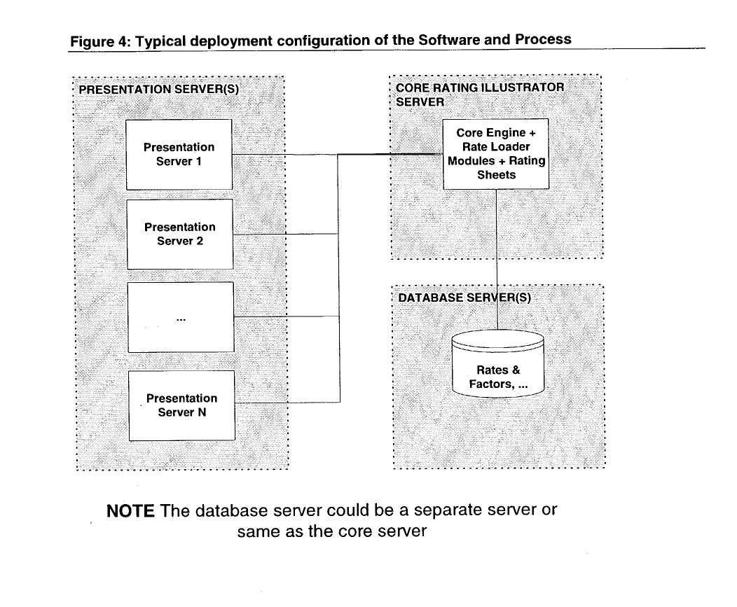

FIG. 4 shows a deployment scenario with multiple presentation servers, a single core engine server and a single database server. In such a configuration, a single Core Engine processes requests from a number of users simultaneously through a number of presentation servers. The disclosed invention facilitates a flexible deployment capability in which the various servers are on a single machine or can be distributed across multiple machines. The software environments required for deployment are:

Java Development Kit (JDK)

Java 2 Enterprise Edition (J2EE) Application Server

Relational Database

Microsoft Office

As will be apparent to those skilled in the art, the disclosed invention is not limited to the specific embodiment that is presently described herein, but can be otherwise variously embodied within the scope of the following claims.

What is claimed is:

1. A system for making calculations, said system comprising:
A business specification that provides commands in accordance with selected definitions, assumptions and business rules;
A family of blueprints for implementing calculations, each blueprint of said blueprint family including rating documents that precisely specify formulas, and a rate loader document that specifies how rates and factors are to be loaded during the calculations, said blueprint being responsive to business specification commands to provide a blueprint signal; and
A core engine that is responsive to blueprint signals and that is also responsive to operator command signals and to acquired data to provide a calculation output signal.

2. The system of claim 1 where said core engine selects a blueprint from the family of blueprints, said core engine selecting the blueprint in accordance with the calculation input command.

3. The system of claim 2 wherein said core engine determines the input data that is required to make the commanded calculation in accordance with the selected blueprint.

4. The system of claim 3 wherein said core engine loads selected data in response to the blueprint.

5. The system of claim 4 wherein said blueprint further includes a user interface, said blueprint being further responsive to form specification commands that define the user interface.

6. The system of claim 4 wherein said system includes a rate loader that is responsive to command signals from rates and loader specifications of the blueprint.

7. The system of claim 6 further comprising a presentation layer for presenting user interface forms.

8. The system of claim 7 wherein said presentation layer receives and verifies input data.

9. The system of claim 8 wherein said rate loader is responsive to the rate loader specification of said blueprint to acquire rates and factor data and supply such rates and factor data to the core engine.

10. A process of performing calculations in a core engine, said process comprising the steps of:
Developing business specifications that define the terms, assumption and rules that express the steps for making a calculation;
Creating a family of blueprints, each of said blueprints corresponding to a selected one of the developed business specifications, each of said blueprints respectively including rating sheets that define the calculations as formulas and also respectively including a rate loader specification that specifies how rates and factors are acquired during the calculations in the core engine;
Providing an initiation signal to the core engine to cause the core engine to begin calculations;
Inputting the data from a selected blueprint into the core engine to determine the particular rating sheet and rate factors corresponding to the selected blueprint;
Acquiring data in the rate loader in accordance with the blueprint instructions;
Performing the computations in the core engine in response to data acquired by the rate loader; and
Providing an output command in accordance with the completed computations.

11. The process of claim 10 wherein said business specifications are developed from product definitions and modification to business rules.

12. The process of claim 11 wherein said step of creating a blueprint further includes developing a user interface.

13. The process of claim 12 wherein the user interface is developed by selecting a field having a predetermined set of properties.

14. The process of claim 11 wherein the rate loader reads the rate loader specification of the blueprint and provides appropriate data to the core engine in response to commands and intermediate calculations from the core engine.

15. The process of claim 14 wherein the step of creating the blueprints includes rating sheets that are organized into a first subpart, said first subpart defining all of the inputs that are needed to perform the calculation for all applications.

16. The process of claim 15 wherein said step of creating the blueprint includes rating sheets that include a second subpart, said second subpart defining all of the rates and factors that are required to perform the computation in all applications.

17. The process of claim 16 wherein said step of creating the blueprints includes rating sheets that include a third subpart, said third subpart separating the calculator into a number of parts, each of said parts corresponding to a logical part of the computation.

18. The process of claim 17 wherein said step of creating the blueprints includes rating sheets that include a fourth subpart, said fourth subpart defining all of the outputs that are applicable to a given calculation, including all intermediate values and the final results of the calculation.
